(19) United States
(12) Patent Application Publication
(10) Pub. No.: US 2013/0110465 A1
(43) Pub. Date: May 2, 2013

(54) CHIP STRUCTURE HAVING HISTORY RECORDING UNIT

(71) Applicants: Chun-Ming Huang, Hsinchu City (TW); Chi-Sheng Lin, Hsinchu City (TW); Chien-Ming Wu, Hsinchu City (TW)

(72) Inventors: Chun-Ming Huang, Hsinchu City (TW); Chi-Sheng Lin, Hsinchu City (TW); Chien-Ming Wu, Hsinchu City (TW)

(73) Assignee: National Chip Implementation Center National Applied Research Laboratories, Hsinchu City (TW)

(21) Appl. No.: 13/312,219

(22) Filed: Dec. 6, 2011

(30) Foreign Application Priority Data
Oct. 31, 2011 (TW) 100139648

(51) Int. Cl. G06F 17/40

(52) U.S. Cl. 702/187

(57) ABSTRACT

A chip structure having a history recording unit is provided. The chip structure includes a core circuit unit in addition to the history recording unit. The history recording unit includes a sensing unit, a record unit, and a deliver unit. The sensing unit detects the status of the core circuit unit and generates history information accordingly. The history information is saved into the record unit and can be further output by the deliver unit. Thus, the history information of the chip structure can be recorded and effectively used to eliminate the reliability problem of the chip structure.

### BACKGROUND OF THE INVENTION

1. Technical Field

The present invention relates to a chip structure having a history recording unit. More particularly, the present invention relates to a chip structure having a history recording unit for enhancing the reliability of the chip structure.

2. Description of Related Art

Nowadays, electronic products must pass strict reliability tests before they can be sold on the market. Passing the reliability tests not only ensures product reliability, meaning the products will not malfunction within the warranty period, but also prevents the cost of sales from rising due to the handling of defective products. Needless to say, reliable products help maintain manufacturers' reputation. More importantly, as long as defective products are screened out before shipment, their potential threat to lives and properties is removed.

Please refer to FIG. 1 for a schematic view of the structure of a conventional chip 100. The conventional chip 100, as is often the case, is configured for providing only the functions of a core circuit unit 10. Once the conventional chip 100 is supplied with electric power and used for a while, the properties of the transistors in the conventional chip 100 will change. If nothing can be known about the presence and conditions of such changes, the chip 100 may fail at any time, thus posing a high risk to the system. Therefore, the reliability of the chip 100 is critical to integrated circuits.

Generally, it is required that integrated circuits or electronic products be subjected to reliability tests as a quality control measure before shipment. The most frequently used reliability test is the burn-in test, which essentially involves putting a product in a high-temperature environment and allowing the product to operate in that environment for a specific period of time in order to determine the product's quality. Nevertheless, a technique for recording the electric data of a core circuit unit 10 during testing or during use has yet to be proposed.

Taiwan Patent No. I240173 discloses a hierarchical power supply noise-monitoring device and system for very large scale integrated circuits, wherein the noise-monitoring device is fabricated on-chip to measure the noise of a chip. The noise-monitoring system includes a plurality of on-chip noise-monitoring devices distributed strategically across the chip. The noise characteristics of the noise data collected by the noise-monitoring devices are analyzed using a noise-analysis algorithm. Then, a hierarchical noise-monitoring system maps the noise of each core to the system on the chip. However, the technical problem to be solved by this Taiwan patent consists mainly in preventing signal errors attributable to noise.

### SUMMARY OF THE INVENTION

The present invention relates to a chip structure having a history recording unit, wherein the chip structure includes a core circuit unit in addition to the history recording unit. It is an object of the present invention to effectively detect and record the status of the core circuit unit, so as for the user to know the electric property data of the chip structure during use, thereby effectively solving the reliability problem of the chip structure.

The present invention provides a chip structure having a history recording unit, comprising: a core circuit unit; and the history recording unit, comprising: a sensing unit electrically connected to the core circuit unit and configured for detecting a use time and a use status of the core circuit unit and generating history information accordingly; a record unit electrically connected to the sensing unit and configured for recording the history information; and a deliver unit formed as an output unit, electrically connected to the record unit, and configured for outputting the history information.

Implementation of the present invention at least involves the following inventive steps:

1. The status of the chip structure can be detected and recorded in a timely and effective manner.

2. The use status of the core circuit can be effectively known, thus eliminating the reliability problem of the core circuit.

3. The working voltage or working frequency of the core circuit can be changed dynamically.

### BRIEF DESCRIPTION OF THE DRAWINGS

The structure as well as a preferred mode of use, further objects, and advantages of the present invention will be best understood by referring to the following detailed description of some illustrative embodiments in conjunction with the accompanying drawings, in which:

FIG. 1 is a schematic view of the structure of a conventional chip;

FIG. 2 is a circuit block diagram of a chip structure having a history recording unit according to an embodiment of the present invention;

FIG. 3 is a circuit block diagram of a history recording unit according to an embodiment of the present invention; and

FIG. 4 is a circuit block diagram of a chip structure having a history recording unit according to an embodiment of the present invention, wherein the chip structure further includes an input unit.

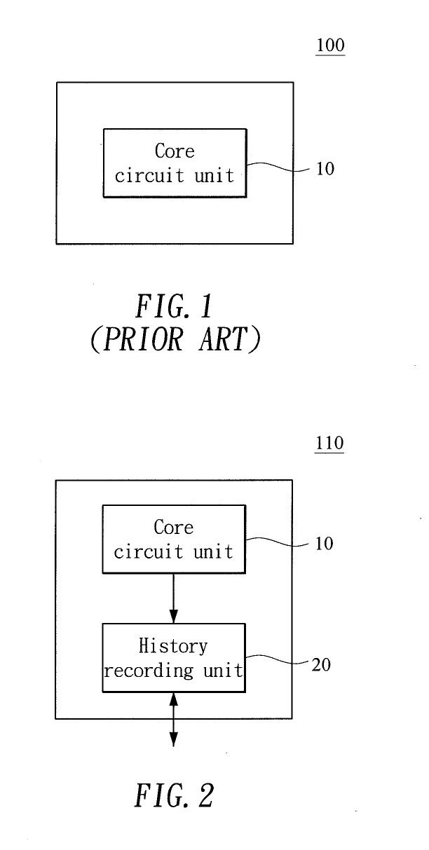

### DETAILED DESCRIPTION OF THE INVENTION

Referring to FIG. 2 for an embodiment of the present invention, a chip structure having a history recording unit is generally indicated at 110 and includes a core circuit unit 10 and a history recording unit 20.

The core circuit unit 10 is the most important unit as far as microprocessors are concerned. The core circuit unit 10 is configured for handling the huge computing demand of the product's system.

The history recording unit 20 is configured to timely and effectively reflects the use status of the core circuit unit 10. As the core circuit unit 10 is the most important unit, the stability of system operation will be seriously impaired if something happens to the core circuit unit 10 or if the user cannot be prepared for problems that are about to take place in the core circuit unit 10. Hence, the provision of the history recording unit 20 is necessary for bringing the use status of the core circuit unit 10 to the user's awareness in a timely and effective way.

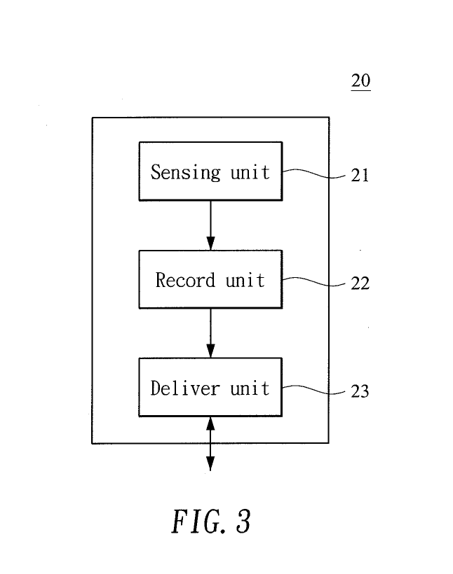

As shown in FIG. 3, the history recording unit 20, which can be fabricated at the same time as the core circuit unit 10, includes a sensing unit 21, a record unit 22, and a deliver unit 23.

The sensing unit 21 detects the core circuit unit 10 in order to know the use status thereof effectively. More particularly, the sensing unit 21 is electrically connected to the core circuit unit 10 and detects the use time and the use status of the core circuit unit 10. Then, the sensing unit 21 generates history information according to the detection results. In addition to the use time and the use status of the core circuit unit 10, the sensing unit 21 detects a voltage, a current, and a temperature condition and generates more history information accordingly. This allows the various aspects of the status of the core circuit unit 10 to be known comprehensively.

The record unit 22 can be a non-volatile storage circuit. The record unit 22 is electrically connected to the sensing unit 21 and is configured to dynamically and continuously record the history information output from the sensing unit 21. To ensure data accuracy, the history information recorded in the record unit 22 can be read-only and non-modifiable. Now that the record unit 22 keeps a complete record of the status of the core circuit unit 10, the user can analyze the history information in order to know or adjust the status of the core circuit unit 10 opportunely. Preventive measures can also be taken in advance, if necessary. Thus, the reliability of the core circuit unit 10 is increased, and system stability enhanced.

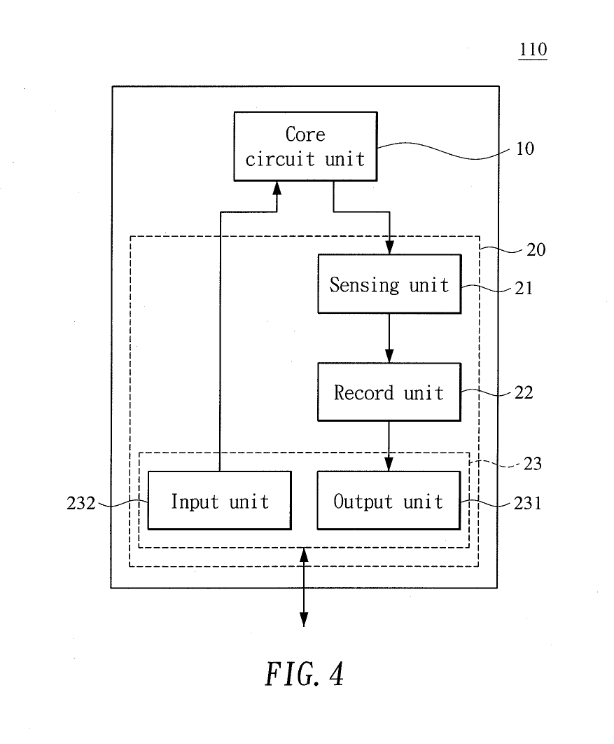

Referring to FIG. 4, the deliver unit 23 is configured as an output unit 231. The deliver unit 23 is electrically connected to the record unit 22 so that, whenever the user wishes to read and analyze the history information, the history information can be outputted via the deliver unit 23 for further use. Apart from serving as the output unit 231, the deliver unit 23 may further include an input unit 232. If analysis of the history information demands the setting of the core circuit unit 10 be adjusted, the input unit 232 can receive the user's instruction, which instructs the core circuit unit 10 to take such actions as changing the working voltage, the working frequency, and so on. This helps increase the service life of the core circuit unit 10.

Like a car odometer, which allows a driver to know the use status of the car, the history recording unit 20 of the disclosed chip structure 110 records the electric property data of the chip structure 110 during use so that the user can know and, if necessary, dynamically change the use status of the important core circuit unit 10 of the chip structure 110 (e.g., by adjusting the working voltage or working frequency of the core circuit unit 10), with a view to extending the service life of the chip structure 110. Moreover, the user can know in time if the chip structure 110 is about to fail and then take the necessary steps to maintain system stability.

The features of the present invention are disclosed above by the preferred embodiment to allow persons skilled in the art to gain insight into the contents of the present invention and implement the present invention accordingly. The preferred embodiment of the present invention should not be interpreted as restrictive of the scope of the present invention. Hence, all equivalent modifications or amendments made to the aforesaid embodiment should fall within the scope of the appended claims.

What is claimed is:

1. A chip structure having a history recording unit, comprising:
a core circuit unit; and
the history recording unit, comprising:
a sensing unit electrically connected to the core circuit unit and configured for detecting a use time and a use status of the core circuit unit and generating history information accordingly;
a record unit electrically connected to the sensing unit and configured for recording the history information; and
a deliver unit formed as an output unit, electrically connected to the record unit, and configured for outputting the history information.

2. The chip structure of claim 1, wherein the sensing unit is configured for further detecting a voltage, a current, or a temperature condition.

3. The chip structure of claim 1, wherein the record unit is a non-volatile storage circuit.

4. The chip structure of claim 1, wherein the deliver unit further comprises an input unit for receiving an external instruction, and the external instruction instructs actions of the core circuit unit.
